(19) United States
(12) Patent Application Publication
(10) Pub. No.: US 2026/0359062 A1
(43) Pub. Date: Nov. 12, 2026

(54) Verification Method and Apparatus for Server

(71) Applicant: SUZHOU METABRAIN INTELLIGENT TECHNOLOGY CO., LTD., Suzhou, Jiangsu (CN)

(72) Inventors: Xin XU, Suzhou, Jiangsu (CN); Baoxi WU, Suzhou, Jiangsu (CN); Chunchao HAN, Suzhou, Jiangsu (CN); Guozhen XU, Suzhou, Jiangsu (CN); Shiwei CUI, Suzhou, Jiangsu (CN); Chuanguo WANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 19/125,674

(22) PCT Filed: Jun. 29, 2023
(86) PCT No.: PCT/CN2023/104191

§ 371 Date: Apr. 29, 2025

(30) Foreign Application Priority Data
Dec. 19, 2022 (CN) 202211634914.4

(51) Int. Cl. G06F 9/4401; G06F 1/26

(52) U.S. Cl. CPC G06F 9/4401; G06F 1/26

(57) ABSTRACT

A verification method and apparatus for a server are provided. The method includes: in a case that a power state of an in-band management system is a powered-on state, whether initialization data of a basic input output system in the in-band management system is integral is determined, and a determination result is obtained; in a case that the determination result indicates yes, a power-up instruction is output to the in-band management system, the basic input output system is run, and metric chain information is transmitted; and according to the metric chain information which is received, integrity of components other than the initialization data of the basic input output system in the in-band management system is verified.

### CROSS-REFERENCE TO RELATED APPLICATIONS

This application is a National Stage Entry under 35 U.S.C. § 371 of PCT International Application No. PCT/CN2023/104191 filed on Jun. 29, 2023, which claims the priority to Chinese Patent Application No. 202211634914.4, filed with the China National Intellectual Property Administration on Dec. 19, 2022 and entitled “Verification method and apparatus for server”, the entire contents of each of which are incorporated herein by reference.

### TECHNICAL FIELD

Embodiments of the disclosure relate to the field of server security, and particularly relate to a verification method and apparatus for a server, a non-volatile readable storage medium, and an electronic device.

### BACKGROUND

The rise of cloud computation and big data has called for a server carrying increasing computing power. As a basic unit of a data center, the server runs important information such as a service system and user data. Malicious tampering with server hardware will cause risks of tampering with and stealing information in the server.

A trusted root, a type of security hardware that is passively invoked, can complete integrity collection and integrity verification only after invoked by firmware. Thus, only by ensuring security of a code that initially uses the trusted root, security and credibility of subsequent operations for the trusted root can be ensured. At present, detection of boot loader codes of a server depends on a function (for instance, an Intel PFR technology or an Intel TXT technology) of a specific central processing unit (CPU). However, these technologies are incompatible with all processors. Alternatively, a technology is used to verify a basic input output system (BIOS) through a baseboard management controller (BMC). The technology of using the BMC to verify the BIOS is only effective in a case of loading BIOS firmware, and can verify only the BIOS firmware itself instead of obtaining integrity of other components. The components include a redundant arrays of independent disks (Raid) card, a graphics card, an operating system kernel, etc.

In view of that, it is urgent to invent a method for verifying integrity of components other than the BIOS firmware in the server and ensuring security and credibility of a hardware environment when an operating system is running.

### SUMMARY

An embodiment of the disclosure provides a verification method for a server. The verification method is applied to a baseboard management controller. The server includes an in-band management system. The verification method includes the following steps: in a case that a power state of the in-band management system is a powered-on state, whether initialization data of a basic input output system in the in-band management system is integral is determined, and a determination result is obtained; in a case that the determination result indicates that the initialization data of the basic input output system in the in-band management system is integral, a power-up instruction is output to the in-band management system, the basic input output system is run, and metric chain information is transmitted; and according to the metric chain information which is received, integrity of components other than the initialization data of the basic input output system in the in-band management system is verified.

In an embodiment, the verification method further includes the following step: before whether the initialization data of the basic input output system in the in-band management system is integral is determined, the power state of the in-band management system is inspected. The power state includes: the powered-on state, a run state, and a powered-off state.

In an embodiment, the steps that whether the initialization data of the basic input output system in the in-band management system is integral is determined, and the determination result is obtained include the following steps: a metric value of the initialization data of the basic input output system is computed, and metric value information is obtained; and whether the metric value information is integral is determined according to a reference value library, and the determination result is obtained. The reference value library includes integrity values of a plurality of components of the basic input output system corresponding to the basic input output system.

In an embodiment, the verification method further includes the following steps: an update request of the basic input output system and an updated basic input output system (BIOS) file are obtained, where the BIOS file includes updated integrity values of the plurality of components of the basic input output system; the BIOS file is parsed according to the update request, and an integrity value set corresponding to the update request is obtained; and the reference value library is updated based on the integrity value set.

In an embodiment, the verification method further includes the following step: in a case that the determination result indicates that the initialization data of the basic input output system in the in-band management system is not integral, the components other than the initialization data of the basic input output system in the in-band management system are powered off.

In an embodiment, the verification method further includes the following steps: the metric value information is transmitted to the basic input output system, and the metric chain information is generated by the basic input output system according to the metric value information and integrity information of the components other than the initialization data of the basic input output system in the in-band management system.

In an embodiment, the step that the metric value information is transmitted to the basic input output system includes the following steps: a session key is exchanged with the basic input output system, a first key is obtained, and a second key is obtained by the basic input output system; the metric value information is encrypted through the second key, and metric value ciphertext is generated; and the metric value ciphertext is transmitted to the basic input output system, the metric value ciphertext is decrypted by the basic input output system according to the second key, and the metric value information is obtained.

In an embodiment, the verification method further includes the following steps: before the integrity of the components other than the initialization data of the basic input output system in the in-band management system is verified according to the metric chain information, metric chain ciphertext is decrypted through the first key, and the metric chain information is obtained. The metric chain ciphertext is obtained by the basic input output system according to the metric value information and the integrity information of the components other than the initialization data of the basic input output system in the in-band management system.

In an embodiment, the verification method further includes the following steps: a first moment of transmitting the metric value information to the basic input output system and a second moment of receiving the metric chain information are recorded; whether a time difference between the first moment and the second moment is greater than a preset threshold is determined; and in a case that a determination result indicates that the time difference between the first moment and the second moment is greater than the preset threshold, the components other than the initialization data of the basic input output system in the in-band management system are powered off.

Another embodiment of the disclosure provides another verification method for a server. The server includes an in-band management system. The verification method is applied to a basic input output system in the in-band management system. The verification method includes the following steps: in a case that a power state of the in-band management system is a powered-on state, a power-on signal is transmitted to a baseboard management controller, whether initialization data of the basic input output system is integral is determined by the baseboard management controller, and a power-up instruction is output in a case that a determination result indicates that the initialization data of the basic input output system is integral; and in a case of receiving the power-up instruction, the basic input output system is controlled to run, metric chain information is transmitted to the baseboard management controller, and integrity of components other than the initialization data of the basic input output system in the in-band management system is verified by the baseboard management controller according to the metric chain information which is received.

In an embodiment, the verification method further includes the following step: in a case that the determination result indicates that the initialization data of the basic input output system is not integral, a control signal transmitted by the baseboard management controller is received. The control signal is used to control the components other than the initialization data of the basic input output system in the in-band management system to be powered off.

In an embodiment, the verification method further includes the following steps: an update request of the basic input output system and an updated basic input output system (BIOS) file are transmitted to the baseboard management controller, the BIOS file is parsed by the baseboard management controller according to the update request, an integrity value set corresponding to the update request is obtained, and a reference value library is updated based on the integrity value set. The BIOS file includes updated integrity values of a plurality of components of the basic input output system.

In an embodiment, the verification method further includes the following steps: metric value information transmitted by the baseboard management controller is received, where the metric value information includes a metric value of the initialization data of the basic input output system; integrity information of the components other than the initialization data of the basic input output system in the in-band management system is obtained; and the metric chain information is generated according to the metric value information and the integrity information.

In an embodiment, the step that the metric value information transmitted by the baseboard management controller is received includes the following steps: a session key is exchanged with the baseboard management controller, a second key is obtained, and a first key is obtained by the baseboard management controller, where the second key is used to encrypt the metric value information and generate metric value ciphertext; and the metric value ciphertext is decrypted through the second key, and the metric value information is obtained.

In an embodiment, the step that the metric chain information is transmitted to the baseboard management controller includes the following steps: the metric chain information is encrypted through the first key, and metric chain ciphertext is obtained; and the metric chain ciphertext is transmitted to the baseboard management controller, the metric chain ciphertext is decrypted through the first key by the baseboard management controller, and the metric chain information is obtained.

In an embodiment, the verification method further includes the following step: in a case that a time difference between a first moment and a second moment is greater than a preset threshold, a control signal transmitted by the baseboard management controller is received. The first moment is a moment of receiving the metric value information transmitted by the baseboard management controller. The second moment is a moment of transmitting the metric chain information to the baseboard management controller. The control signal is used to control the components other than the initialization data of the basic input output system in the in-band management system to be powered off.

Another embodiment of the disclosure provides a verification apparatus for a server. The verification apparatus is applied to a baseboard management controller. The server includes an in-band management system. The verification apparatus includes: a determination module used to determine, in a case that a power state of the in-band management system is a powered-on state, whether initialization data of a basic input output system in the in-band management system is integral, and obtain a determination result; an output module used to output, in a case that the determination result indicates that the initialization data of the basic input output system in the in-band management system is integral, a power-up instruction to the in-band management system, run the basic input output system, and transmit metric chain information; and a verification module used to verify, according to the metric chain information which is received, integrity of components other than the initialization data of the basic input output system in the in-band management system.

Another embodiment of the disclosure provides another verification apparatus for a server. The verification apparatus is applied to a basic input output system in an in-band management system. The server includes the in-band management system. The verification apparatus includes: a first transmission module used to transmit, in a case that a power state of the in-band management system is a powered-on state, a power-on signal to a baseboard management controller, determine whether initialization data of the basic input output system is integral by the baseboard management controller, and output a power-up instruction in a case that a determination result indicates that the initialization data of the basic input output system is integral; and a second transmission module used to control, in a case of receiving the power-up instruction, the basic input output system to be run, transmit metric chain information to the baseboard management controller, and verify, by the baseboard management controller, integrity of components other than the initialization data of the basic input output system in the in-band management system according to the metric chain information which is received.

Another embodiment of the disclosure further provides a non-volatile readable storage medium. The non-volatile readable storage medium stores a computer program. The computer program is used to execute steps of any one of the method embodiments at runtime.

Still another embodiment of the disclosure further provides an electronic device. The electronic device includes a memory and a processor. A computer program is stored in the memory. The processor is configured to run the computer program, so as to execute steps of any one of the method embodiments.

### BRIEF DESCRIPTION OF THE DRAWINGS

FIG. 1 is a flowchart of a verification method for integrity of a server according to an embodiment of the disclosure;

FIG. 2 is a block diagram of a system structure used in a verification method for integrity of a server according to an embodiment of the disclosure;

FIG. 3 is a flowchart of updating a reference value in a verification method for integrity of a server according to an embodiment of the disclosure;

FIG. 4 is a diagram of a booting order of a verification method for integrity of a server according to an embodiment of the disclosure;

FIG. 5 is a schematic diagram of an entire flow of a verification method for integrity according to an embodiment of the disclosure;

FIG. 6 is a flowchart of another verification method for integrity of a server according to an embodiment of the disclosure;

FIG. 7 is a structural block diagram of a verification apparatus for integrity of a server according to an embodiment of the disclosure; and

FIG. 8 is a structural block diagram of another verification apparatus for integrity of a server according to an embodiment of the disclosure.

### DETAILED DESCRIPTION OF THE EMBODIMENTS

Embodiments of the disclosure will be described in detail below with reference to the accompanying drawings in conjunction with the embodiments.

It should be noted that the terms such as “first” and “second” in the description and claims of the disclosure and in the drawings are used to distinguish between similar objects and not necessarily to describe a particular order or sequential order.

For convenience of understanding, some nouns or terms involved in the embodiments of the disclosure will be described below.

A trusted root is a security device that provides a trusted service according to relevant specifications. Trusted root specifications currently published include a trusted platform module (TPM) and a trusted cryptography module (TCM).

A baseboard management controller (BMC) is a managing unit independent of a computing unit of a server, is connected to the computing unit of the server through a hardware bus, and is used to monitor a hardware state and a run state of a computer.

A basic input output system (BIOS) is a program solidified in a storage chip. A code executed first by the computing unit of the computer is generally used to complete computer hardware initialization and hardware self-check, and provide a hardware management interface for an operating system.

An in-band management system is a system that uses a unified physical channel to transmit management control information and data information. In the field of servers, an in-band management operation is to manage each hardware unit in the computing unit of the server.

An out-of-band management system transmits the management control information and the data information through different physical channels, which are completely independent of each other and do not influence each other. In the field of servers, an out-of-band management operation is to manage each hardware unit on the server through a network service provided by the BMC.

A managing unit and a computing unit are defined as follows: the managing unit is used to supervise and control a state of each piece of hardware on the computer. In the field of servers, the managing unit refers to a BMC system. The computing unit refers to a central processing unit (CPU), an internal storage, a memory and other hardware that the operating system depends on at runtime, and is also commonly referred to as a host. The managing unit and the computing unit run independently of each other, and only transmit management information through a limited hardware bus. In order to reduce ambiguity, in this case, the BMC, the managing unit and out-of-band management are identical concepts, which indicates that each piece of hardware on the server is monitored through the BMC; and the host, the computing unit and in-band management are identical concepts, which indicates that the CPU, the internal storage, the memory and other hardware transmit information through physical links.

BootBlock is a firmware volume, includes a program first loaded and run in BIOS firmware, is used for an initial initialization operation, and is a program first executed after the host is powered on.

### Embodiment 1

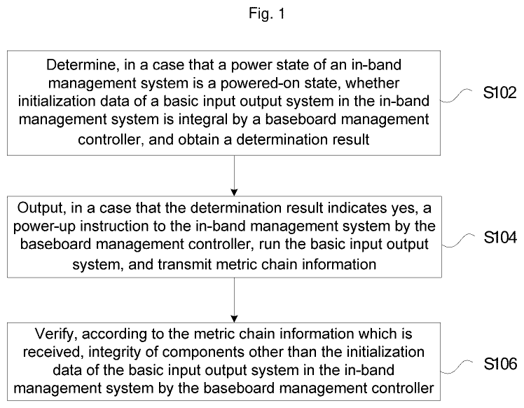

The embodiment provides a verification method for integrity of a server. FIG. 1 is a flowchart of a verification method for integrity of a server according to an embodiment of the disclosure. As shown in FIG. 1, the flow includes the following steps:
S102, in a case that a power state of an in-band management system is a powered-on state, whether initialization data of a basic input output system in the in-band management system is integral is determined by a baseboard management controller, and a determination result is obtained;
S104, in a case that the determination result indicates yes, a power-up instruction is output to the in-band management system by the baseboard management controller, the basic input output system is run, and metric chain information is transmitted; and
S106, according to the received metric chain information, integrity of components other than the initialization data of the basic input output system in the in-band management system is verified by the baseboard management controller.

Through the steps, before the BIOS is loaded, whether the initialization data of the basic input output system (BIOS) in the in-band management system is integral is determined by the baseboard management controller (BMC), such that integrity of BootBlock that is run by the BIOS first can be verified, and security and credibility of an initial run state of the BIOS can be ensured. After execution of the BIOS is completed, the BMC receives a currently booted and collected metric chain transmitted by the BIOS, and secondary verification is conducted to verify integrity of hardware, kernels and other components. Only after integrity verification of the BIOS, hardware, kernels and other components is completed can an operating system be booted. Thus, integrity of the BIOS and other components in the in-band management system can be verified by the BMC by stages. In this way, a problem that the BMC fails to obtain integrity of other components (such as a redundant arrays of independent disks (Raid) card, a graphics card, and an operating system kernel) is solved, and an effect that the BMC can verify the integrity of the BIOS and other components in the server is achieved.

Moreover, through the steps, the server may complete measurement and integrity verification of an initial running program of the BIOS without relying on a specific CPU architecture. The in-band management system collects data of a verified component. An out-of-band management system executes a verification logic, thus implementing isolation of verification data from the verification logic. An out-of-band manager may directly obtain integrity information of all the components of the server from the BMC without logging in to an in-band system.

In S102, in a case that the power state of the in-band management system is the powered-on state, whether the initialization data of the basic input output system (BIOS) in the in-band management system is integral is determined by the baseboard management controller (BMC), and the determination result is obtained. That is, when a power state of the server changes to a powered-on state (operations of booting, rebooting, quick booting, etc.), first-stage verification of the BIOS is immediately executed.

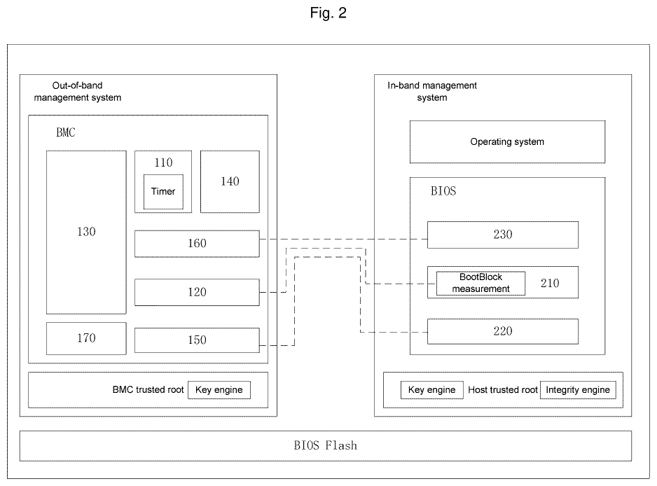

In some optional embodiments, the baseboard management controller (BMC) includes a power state monitoring module 110, as shown in FIG. 2. In this case, the verification method in the embodiment further includes the following step: the power state of the in-band management system is inspected by the power state monitoring module. The power state includes: the powered-on state, a run state, and a powered-off state.

In the embodiment, changes of the power state of the in-band management system may be obtained through the power state monitoring module in the BMC. Thus, when the power state of the server changes to the powered-on state, first-stage verification of the BIOS is immediately executed, such that security and credibility of an initial running logic of the BIOS are ensured.

In order to execute first-stage verification of the BIOS, the baseboard management controller (BMC) includes a first verification module 120, as shown in FIG. 2. In some optional embodiments, the steps that whether the initialization data of the basic input output system (BIOS) in the in-band management system is integral is determined by the BMC, and the determination result is obtained include the following steps: the first verification module computes a metric value of the initialization data of the BIOS, and obtains metric value information, where a boot program having the initialization data is a program first loaded and run in firmware of the BIOS, is used for an initial initialization operation, and is a program first executed after a host is powered on; and the first verification module determines whether the metric value information is integral according to a reference value library, and obtains a determination result. The reference value library includes integrity values of a plurality of basic input output system (BIOS) components corresponding to the BIOS.

Specifically, primary verification is conducted on BootBlock of the BIOS through the first verification module, a metric value of the BootBlock in current BIOS Flash is computed, and BIOS BootBlock is verified according to the reference value library. If verification fails, a host is powered off, to ensure security and credibility of a logic initially executed by the BIOS.

In some optional embodiments, the baseboard management controller (BMC) further includes a reference value management module 130, as shown in FIG. 2. In this case, the verification method in the embodiment further includes the following steps: the reference value management module obtains an update request of the basic input output system (BIOS) and an updated BIOS file, where the BIOS file includes updated integrity values of the plurality of BIOS components; the reference value management module parses the BIOS file according to the update request, and obtains an integrity value set corresponding to the update request; and the reference value library is updated based on the integrity value set.

The reference value management module may not only provide a verification reference value for the verification module, but also provide a reference value update service. After the BMC completes a BIOS update operation, the updated integrity values of the BIOS components may be computed, such that a reference value is updated synchronously to ensure that the updated BIOS and the updated reference value may be synchronized.

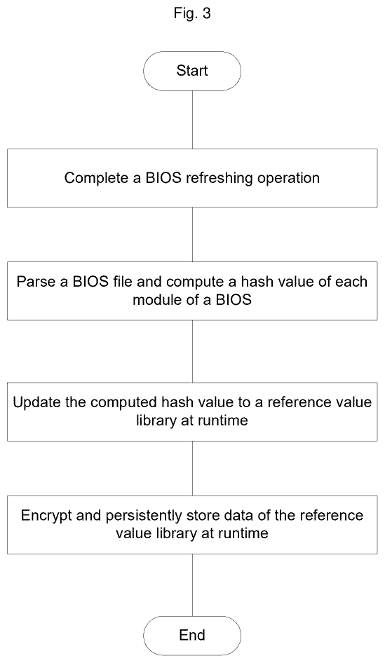

Illustratively, as shown in FIG. 3, an update flow of the reference value may include the following steps:
1) the BMC completes BIOS refreshing: the BMC integrates a functional logic of BIOS refreshing, and the functional logic may further verify integrity and legality of a BIOS file to be refreshed, such that a reference value update logic may reuse an existing logic of using the BMC to update the BIOS, and legality of the BIOS file does not need to be independently verified;
2) the BIOS file is parsed: the BIOS file includes a plurality of BIOS components, such as various firmware volumes (FVs) and SecureBoot, and the integrity values of all the components are computed, that is, hash values (hash functions, or hash values) of all modules of the BIOS are computed;
3) the reference value library is updated at runtime: the integrity value set computed in step 2) is updated to the reference value library at runtime, to ensure that a new BIOS may be booted normally, that is, a reference value library module parses the computed hash value and update the hash value to the reference value library at runtime; and
4) the reference value library is updated: the BMC creates the reference value library at runtime according to the reference value library persistently stored and protected by a trusted root every time the system is booted, such that an update operation should further update the reference value library persistently stored.

In S104, in a case that the determination result indicates yes, the power-up instruction is output to the in-band management system by the baseboard management controller (BMC), the basic input output system (BIOS) is run, and the metric chain information is transmitted.

Specifically, the first verification module transmits the metric value information to the basic input output system (BIOS), and generates the metric chain information by the BIOS according to the metric value information and the integrity information of the components other than the BootBlock of the BIOS in the in-band management system. The metric chain is the integrity information of various components collected based on the trusted root when a computer is booted. The components include the BIOS, an option read-only memory (OpROM), an operating system kernel, etc.

In some optional embodiments, the baseboard management controller (BMC) further includes a control module 140, as shown in FIG. 2. In this case, the verification method in the embodiment further includes the following steps: the power state monitoring module records a first moment of transmitting a metric value of the boot program to the basic input output system (BIOS) and a second moment of receiving the metric chain information; the power state monitoring module determines whether a time difference between the first moment and the second moment is greater than a preset threshold; and in a case that the determination result indicates that the time difference is greater than the preset threshold, the power state monitoring module transmits a power-off instruction to the control module, such that the control module powers off the components other than the BootBlock of the BIOS in the in-band management system according to the power-off instruction. The control module refers to a logic module that controls in-band power-on in an existing BMC, and modules related to integrity verification invoke the module according to a verification result, so as to power off the host.

Specifically, integrity verification in the embodiment has two processes. In order to prevent malicious attackers from bypassing a logic of secondary verification, the power state monitoring module may be provided with a timer, and the timer may be booted for timing. If the metric chain information transmitted by the BIOS fails to be obtained within specified time, it is considered that the BIOS is maliciously modified. In this case, the control module of the host may be invoked to power off the host.

In order to ensure security and reliability of verification data transmitted between the baseboard management controller (BMC) and the basic input output system (BIOS), the BMC and the BIOS ensure security and credibility of interactive data through own trusted roots.

In some optional embodiments, the BMC further includes a first trusted root management module 150, as shown in FIG. 2. In this case, the step that the BMC transmits the metric value of the boot program to the BIOS includes the following steps: the first trusted root management module exchanges a session key with the BIOS, obtains a first key, and obtains a second key by the BIOS; the first trusted root management module encrypts the metric value information through the second key and generates metric value ciphertext; and the first trusted root management module transmits the metric value ciphertext to the BIOS, decrypts the metric value ciphertext by the BIOS through the second key, and obtains the metric value information. The trusted root management module uses a key engine of a trusted root to ensure confidentiality of data. The BMC uses a cryptographic mechanism of the trusted root to ensure confidentiality of data interacting with the BIOS. Meanwhile, in order to ensure security of the reference value library, confidentiality of the reference value library is protected through a key in the trusted root. Session key interaction with the BIOS in a running stage of the BIOS needs to be completed to ensure security of subsequent communication data.

In the optional embodiments, confidentiality of the reference value library is ensured by the BMC. As the BMC has an independent trusted root, a cryptographic engine in the trusted root of the BMC may be used to ensure confidentiality of the reference value library. The BMC uses a cryptographic mechanism of the trusted root to ensure confidentiality of data interacting with the BIOS. Session key interaction with the BIOS is completed in a running stage of the BIOS, thus ensuring security of subsequent communication data.

Meanwhile, the BMC integrates a logic of refreshing BIOS firmware. Thus, an operation of updating the reference value library may be added to the logic of refreshing the BIOS synchronously, and an existing BIOS file verification logic during BIOS update may be reused.

Specifically, the first trusted root management module is the trusted root management module of the BMC, uses the key engine of the trusted root to ensure confidentiality of data, and exchanges the session key with the BIOS after the BMC completes key initialization. If the BMC fails to obtain session key information of the BIOS, circular waiting is conducted to ensure security of subsequent data interaction. In addition, in order to ensure security of the reference value library, confidentiality of the reference value library may be protected through the key in the trusted root.

In S106, according to the received metric chain information, the integrity of the components other than the BootBlock of the basic input output system (BIOS) in the in-band management system is verified by the baseboard management controller (BMC).

In some optional embodiments, the BMC further includes a second verification module 160, as shown in FIG. 2. If the BMC receives metric chain ciphertext encrypted by the BIOS, the first trusted root management module may decrypt the metric chain ciphertext through the first key, and obtain metric chain information; and then the second verification module conducts secondary integrity verification on hardware, kernels and other components on the server according to the metric chain information transmitted by the BIOS, and ensures security and credibility of a hardware environment in which an operating system runs.

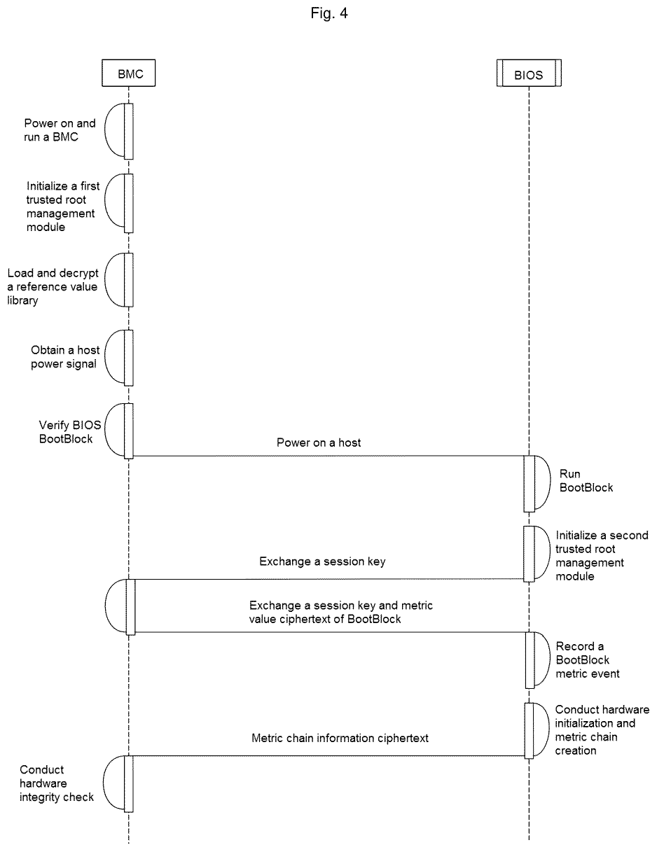

For instance, a diagram of a booting order of a server based on dual trusted roots in the embodiment is as shown in FIG. 4. After the BMC is powered on and runs, the first trusted root management module is initialized, and the reference value library is loaded and decrypted. After the BMC obtains a power signal of the host, the BootBlock of the BIOS is verified according to the reference value library. After first-stage verification of the BIOS is passed, the BMC exchanges the session key with the BIOS, and transmits the metric value ciphertext, and the BMC receives metric chain information ciphertext transmitted by the BIOS, such that hardware integrity verification is conducted.

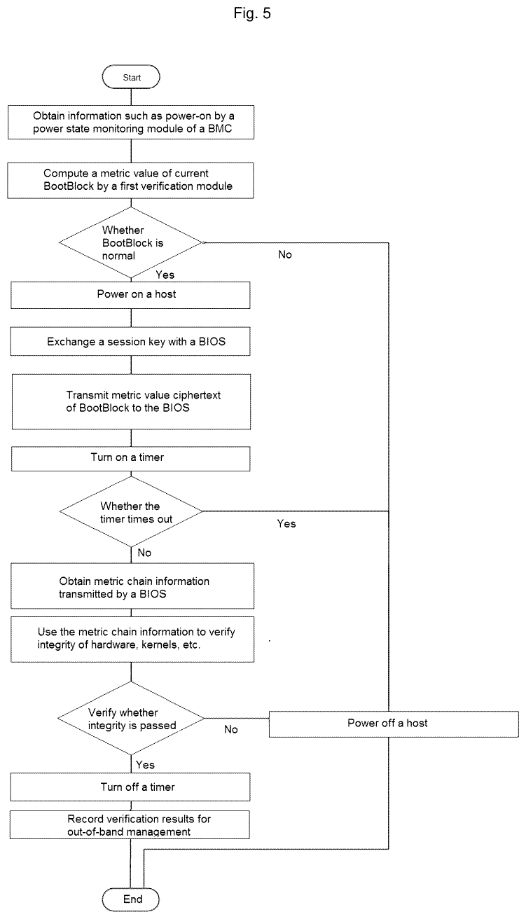

The verification method in the embodiment will be further described with reference to FIG. 5. As shown in the flowchart of FIG. 5, an integrity verification flow may include the following steps:
1) the power state is monitored: information such as power-on is obtained through the power state inspection module of the BMC, and in a case that a server in-band system is powered on, rebooted or quickly booted, the BMC immediately executes verification operations after obtaining signals;
2) BIOS BootBlock is verified: the first verification module of the BMC is used to compute the metric value of the BootBlock in current BIOS Flash, and whether the BIOS BootBlock is normal is verified according to the reference value library; and if verification fails, a host is powered off, to ensure security and credibility of a logic initially executed by the BIOS;
3) the first trusted root management module is initialized: the host is powered on, and after the BIOS starts running, the BMC initializes the first trusted root management module, so as to create the session key required for this time of booting;
4) the session key is exchanged with the BIOS: after the BMC completes key initialization, the session key is exchanged with the BIOS; and if the BIOS fails to obtain session key information of the BMC, circular waiting is conducted to ensure security of subsequent data interaction;
5) the metric value of the BootBlock is transmitted: as the BMC fails to access the trusted root of the BIOS, the BMC needs to transmit metric data of the BootBlock to the in-band system, and the BIOS generates a metric event of the BootBlock and stores the metric event in the trusted root of the in-band system;
6) the timer is booted: as first verification only verifies the integrity of the BootBlock and fails to verify the integrity of other components of the BIOS, in order to prevent failure of execution of a logic of transmitting metric information due to malicious tampering of the other components of the BIOS, the timer is booted to wait for the metric chain information transmitted by the BIOS, the timer may only be turned off if the BMC completes verification within specified time, and if valid metric information fails to be obtained within the specified time, the BIOS is considered to be untrustworthy and a power-off operation is conducted;
7) host integrity verification is conducted: the BMC obtains integrity reference values of all hardware, kernels and other components in the reference value library, and compares the integrity reference values with the obtained metric chain information, and if there is a component whose integrity is damaged, power-off is conducted to ensure security and credibility of an in-band operating system; and
8) verification results are recorded: the BMC records each verification result, and the out-of-band system manager may directly obtain the integrity information of all the components of the in-band system through the BMC without logging in to the in-band system.

From the description of the embodiments, those skilled in the art can clearly understand that the methods according to the embodiments can be implemented through software plus a necessary general-purpose hardware platform, or through hardware. In most cases, the former is a better embodiment. With such understanding, the technical solution of the disclosure, in essence or from the view of part contributing to the prior art, may be embodied in a form of a computer software product. The computer software product is stored in a storage medium (such as an ROM/a random access memory (RAM), a magnetic disk, and an optical disk) and includes several instructions used to enable a terminal device (which may be a mobile phone, a computer, a server, a network device, etc.) to execute the method of each embodiment of the disclosure.

### Embodiment 2

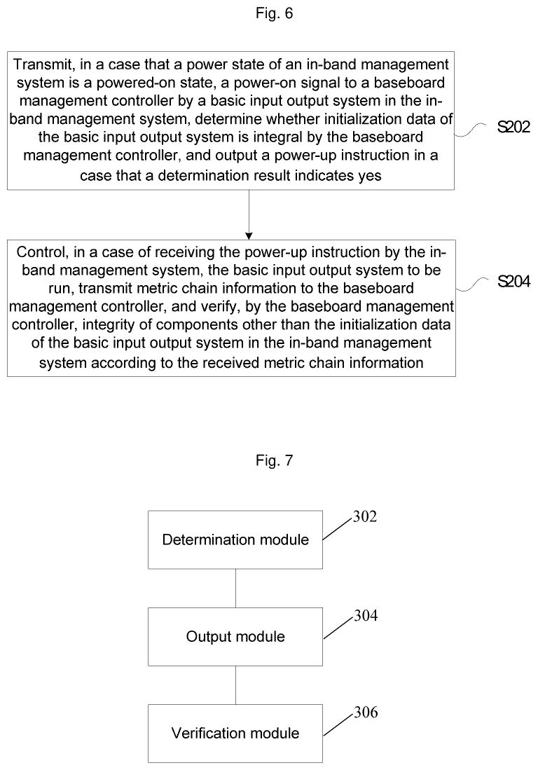

The embodiment provides a verification method for integrity of a server. FIG. 6 is a flowchart of a verification method for integrity of a server according to an embodiment of the disclosure. As shown in FIG. 6, the flow includes the following steps:
S202, in a case that a power state of an in-band management system is a powered-on state, a power-on signal is transmitted to a baseboard management controller by a basic input output system in the in-band management system, whether initialization data of the basic input output system is integral is determined by the baseboard management controller, and a power-up instruction is output in a case that a determination result indicates yes; and
S204, in a case of receiving the power-up instruction by the in-band management system, the basic input output system is controlled to run, metric chain information is transmitted to the baseboard management controller, and the baseboard management controller verifies integrity of components other than the initialization data of the basic input output system in the in-band management system according to the received metric chain information.

Through the steps, the basic input output system (BIOS) of the in-band management system transmits the power-on signal to the baseboard management controller (BMC), and then whether the initialization data of the BIOS is integral is determined by the BMC, such that integrity of BootBlock that is run by the BIOS first can be verified, and security and credibility of an initial run state of the BIOS can be ensured. After execution of the BIOS is completed, a currently booted and collected metric chain is transmitted to the BMC for secondary verification, such that integrity of hardware, kernels and other components is verified. Only after integrity verification of the BIOS, hardware, kernels and other components is completed can an operating system be booted. Thus, integrity of the BIOS and other components in the in-band management system can be verified by stages. In this way, a problem that the BMC fails to obtain integrity of other components (such as a Raid card, a graphics card, and an operating system kernel) is solved, and an effect that the BMC can verify the integrity of the BIOS and other components in the server is achieved.

Moreover, through the steps, the server may complete measurement and integrity verification of an initial running program of the BIOS without relying on a specific CPU architecture. The in-band management system collects data of a verified component. An out-of-band management system executes a verification logic, thus implementing isolation of verification data from the verification logic. An out-of-band manager may directly obtain integrity information of all the components of the server from the BMC without logging in to an in-band system.

In S202, in a case that the power state of the in-band management system is the powered-on state, the power-on signal is transmitted to the baseboard management controller (BMC) by the basic input output system (BIOS) in the in-band management system, whether the initialization data of the BIOS is integral is determined by the BMC, and the power-up instruction is output in a case that the determination result indicates yes.

In a case that the determination result indicates no, the control signal transmitted by the control module in the BMC may be received. The control signal is used to control the components other than the initialization data of the basic input output system in the in-band management system to be powered off.

Specifically, changes of the power state of the in-band management system may be obtained through the power state monitoring module in the BMC. Thus, when the power state of the server changes to the powered-on state, first-stage verification of the BIOS is immediately executed, such that security and credibility of an initial running logic of the BIOS are ensured. Primary verification is conducted on BootBlock of the BIOS through the BMC, a metric value of the BootBlock in current BIOS Flash is computed, and BIOS BootBlock is verified according to the reference value library. If verification fails, a host is powered off, to ensure security and credibility of a logic initially executed by the BIOS.

In some optional embodiments, an update request of the basic input output system and an updated BIOS file are transmitted to the baseboard management controller, the BIOS file is parsed by the baseboard management controller according to the update request, an integrity value set corresponding to the update request is obtained, and a reference value library is updated based on the integrity value set. The BIOS file includes updated integrity values of a plurality of components of the basic input output system.

In S204, in a case of receiving the power-up instruction by the in-band management system, the basic input output system (BIOS) is controlled to run, metric chain information is transmitted to the baseboard management controller (BMC), and the BMC verifies integrity of components other than the BootBlock of the BIOS in the in-band management system according to the received metric chain information.

In some optional embodiments, the basic input output system (BIOS) includes a metric chain module 210, as shown in FIG. 2. In this case, the verification method in the embodiment further includes the following steps: the metric chain module receives metric value information transmitted by the baseboard management controller (BMC), where the metric value information includes a metric value of the initialization data of the BIOS; the metric chain module obtains integrity information of the components other than a boot program (BootBlock) having the initialization data of the BIOS in the in-band management system; and the metric chain module generates the metric chain information according to the metric value information and the integrity information.

In the optional embodiments, the metric chain module may reuse an existing BIOS metric chain technology. When the BIOS is booted, the integrity information of each component is collected, and stored in the trusted root.

Specifically, the metric chain module receives the metric value information transmitted by the BMC, and further generates the metric chain information according to the metric value information and the integrity information of the components other than the BIOS in the in-band management system. The metric chain is the integrity information of various components (such as the BIOS, an OpROM, and an operating system kernel) collected based on a trusted root when a computer is booted.

In order to ensure security and reliability of verification data transmitted between the baseboard management controller (BMC) and the basic input output system (BIOS), the BMC and the BIOS ensure security and credibility of interactive data through own trusted roots.

In some optional embodiments, the BIOS further includes a second trusted root management module 220. As shown in FIG. 2, the step that the BIOS receives the metric value information transmitted by the BMC includes the following steps: the second trusted root management module exchanges a session key with the BMC, obtains a second key, and obtains a first key by the BMC, where the second key is used to encrypt the metric value information and generate metric value ciphertext; and the second trusted root management module decrypts the metric value ciphertext through the second key, and obtains the metric value information.

In the optional embodiments, the second trusted root management module is the trusted root management module of the BIOS, and uses a key engine of a trusted root to ensure confidentiality of data. The BIOS uses a cryptographic mechanism of the trusted root to ensure confidentiality of data interacting with the BMC.

In some optional embodiments, the basic input output system (BIOS) further includes an authentication module 230. As shown in FIG. 2, the step that the metric chain information is transmitted to the baseboard management controller (BMC) includes the following steps: the second trusted root management module encrypts the metric chain information through the first key, and obtains metric chain ciphertext; and the authentication module transmits the metric chain ciphertext to the BMC, decrypts the metric chain ciphertext through the first key by the BMC, and obtains the metric chain information.

In the optional embodiments, based on the metric chain created when the BIOS is booted, the authentication module transmits the metric chain information to the BMC before the BIOS hands over control of the server to a next component, and the BMC verifies the integrity of all hardware, kernels, and other components of the in-band system.

In some optional embodiments, a moment of receiving the metric value information transmitted by the baseboard management controller is recorded as a first moment, and a moment of transmitting the metric chain information to the baseboard management controller is recorded as a second moment. In a case that a time difference between the first moment and the second moment is greater than a preset threshold, the control signal transmitted by the control module in the BMC is received. The control signal is used to control the components other than the initialization data of the basic input output system in the in-band management system to be powered off.

For instance, a diagram of a booting order of a server based on dual trusted roots in the embodiment is as shown in FIG. 4. After first-stage verification of the BIOS by the BMC is passed, the host is controlled to be powered on and run, and the BootBlock runs. The BIOS initializes the second trusted root management module, exchanges the session key with BMC, receives the transmitted metric value ciphertext, then records a BootBlock metric event, and conducts hardware initialization and metric chain creation.

### Embodiment 3

The embodiment provides a verification apparatus for a server. The apparatus is used to implement Embodiment 1 and preferred embodiments, and will not be repeated herein. The term “module”, as used below, may implement a combination of software and/or hardware having predetermined functions. While the apparatus described in the following embodiments is preferably implemented in software, implementation in hardware or a combination of software and hardware is also possible and conceivable.

FIG. 7 is a structural block diagram of a verification apparatus for a server according to an embodiment of the disclosure. As shown in FIG. 7, the apparatus includes:
a determination module 302 used to determine, in a case that a power state of an in-band management system is a powered-on state, whether initialization data of a basic input output system in the in-band management system is integral by a baseboard management controller, and obtain a determination result;
an output module 304 used to output, in a case that the determination result indicates yes, a power-up instruction to the in-band management system by the baseboard management controller, run the basic input output system, and transmit metric chain information; and
a verification module 306 used to verify, according to the received metric chain information, integrity of components other than the initialization data of the basic input output system in the in-band management system by the baseboard management controller.

It should be noted herein that the determination module 302, the output module 304 and the verification module 306 may correspond to S102 to S106 in Embodiment 1. Implementation instances and application scenes of the plurality of modules are consistent with those of the corresponding steps, and are not limited by the content disclosed in Embodiment 1.

Through the modules, before the BIOS is loaded, whether the initialization data of the basic input output system (BIOS) in the in-band management system is integral is determined by the determination module 302, such that integrity of BootBlock that is run by the BIOS first can be verified, and security and credibility of an initial run state of the BIOS can be ensured. After execution of the BIOS is completed, the BMC receives a currently booted and collected metric chain transmitted by the BIOS, and the verification module 306 conducts secondary verification to verify integrity of hardware, kernels and other components. Only after integrity verification of the BIOS, hardware, kernels and other components is completed can an operating system be booted. Thus, integrity of the BIOS and other components in the in-band management system can be verified by the BMC by stages. In this way, a problem that the BMC fails to obtain integrity of other components (such as a Raid card, a graphics card, and an operating system kernel) is solved, and an effect that the BMC can verify the integrity of the BIOS and other components in the server is achieved.

In some optional embodiments, the baseboard management controller (BMC) includes a power state monitoring module 110. As shown in FIG. 2, the power state monitoring module is used to inspect the power state of the in-band management system. The power state includes: a powered-on state, a run state, and a powered-off state.

For first-stage verification of the BIOS, the baseboard management controller (BMC) includes a first verification module 120. As shown in FIG. 2, the first verification module is used to compute a metric value of the initialization data of the BIOS, and obtain metric value information. A boot program having the initialization data is a program first loaded and run in firmware of the BIOS, is used for an initial initialization operation, and is a program first executed after a host is powered on. The first verification module is further used to determine whether the metric value information is integral according to a reference value library, and obtain a determination result. The reference value library includes integrity values of a plurality of BIOS components corresponding to the BIOS.

In some optional embodiments, the baseboard management controller (BMC) further includes a reference value management module 130. As shown in FIG. 2, the reference value management module is used to obtain an update request of the basic input output system (BIOS) and an updated BIOS file. The BIOS file includes updated integrity values of the plurality of BIOS components. The reference value management module is further used to parse the BIOS file according to the update request, and obtain an integrity value set corresponding to the update request. The reference value management module is further used to update the reference value library based on the integrity value set.

In some optional embodiments, the first verification module is further used to transmit the metric value information to the basic input output system (BIOS), and generate the metric chain information by the BIOS according to the metric value information and integrity information of components other than the BootBlock of the BIOS in the in-band management system. The metric chain is the integrity information of various components (such as the BIOS, an OpROM, and an operating system kernel) collected based on a trusted root when a computer is booted.

In some optional embodiments, the baseboard management controller (BMC) further includes a control module 140. As shown in FIG. 2, the power state monitoring module is further used to record a first moment of transmitting a metric value of the boot program to the basic input output system (BIOS) and a second moment of receiving the metric chain information. The power state monitoring module is used to determine whether a time difference between the first moment and the second moment is greater than a preset threshold. In a case that the determination result indicates that the time difference is greater than the preset threshold, the power state monitoring module transmits a power-off instruction to the control module, such that the control module powers off the components other than the BootBlock of the BIOS in the in-band management system according to the power-off instruction. The control module refers to a logic module that controls in-band power-on in an existing BMC, and modules related to integrity verification invoke the module according to a verification result, so as to power off the host.

In order to ensure security and reliability of verification data transmitted between the BMC and the BIOS, the BMC and the BIOS ensure security and credibility of interactive data through own trusted roots.

In some optional embodiments, the BMC further includes a first trusted root management module 150. As shown in FIG. 2, the first trusted root management module is used to exchange a session key with the BIOS, obtain a first key, and obtain a second key by the BIOS. The first trusted root management module is further used to encrypt the metric value information through the second key and generate metric value ciphertext. The first trusted root management module is further used to transmit the metric value ciphertext to the BIOS, decrypt the metric value ciphertext by the BIOS through the second key, and obtain the metric value information. The trusted root management module uses a key engine of a trusted root to ensure confidentiality of data. The BMC uses a cryptographic mechanism of the trusted root to ensure confidentiality of data interacting with the BIOS. Meanwhile, in order to ensure security of the reference value library, confidentiality of the reference value library is protected through a key in the trusted root. Session key interaction with the BIOS in a running stage of the BIOS needs to be completed to ensure security of subsequent communication data.

In some optional embodiments, the BMC further includes a second verification module 160. As shown in FIG. 2, the first trusted root management module is further used to decrypt metric chain ciphertext through the first key, and obtain metric chain information. The second verification module is used to conduct secondary integrity verification on hardware, kernels and other components on the server according to the metric chain information transmitted by the BIOS, and ensure security and credibility of a hardware environment in which an operating system runs.

The BMC may further include an integrity information maintenance module 170. As shown in FIG. 2, in order to maintain a result of integrity verification, an out-of-band manager may invoke the module to obtain the result of integrity verification.

It should be noted that all the modules may be implemented by software or hardware. In the latter case, the modules are located in a same processor, or all the modules are separately located in different processors in any combination form, which is not restrictive.

### Embodiment 4

The embodiment provides another verification apparatus for a server. The apparatus is used to implement Embodiment 2 and preferred embodiments, and will not be repeated herein. The term “module”, as used below, may implement a combination of software and/or hardware having predetermined functions. While the apparatus described in the following embodiments is preferably implemented in software, implementation in hardware or a combination of software and hardware is also possible and conceivable.

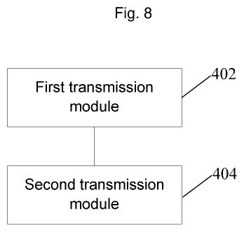

FIG. 8 is a structural block diagram of a verification apparatus for a server according to an embodiment of the disclosure. As shown in FIG. 8, the apparatus includes:
a first transmission module 402 used to transmit, in a case that a power state of an in-band management system is a powered-on state, a power-on signal to a baseboard management controller by a basic input output system in the in-band management system, determine whether initialization data of the basic input output system is integral by the baseboard management controller, and output a power-up instruction in a case that a determination result indicates yes; and
a second transmission module 404 used to control, in a case of receiving the power-up instruction by the in-band management system, the basic input output system to be run, transmit metric chain information to the baseboard management controller, and verify, by the baseboard management controller, integrity of components other than the initialization data of the basic input output system in the in-band management system according to the received metric chain information.

It should be noted herein that the determination module 402 and the output module 404 may correspond to S202 to S206 in Embodiment 2. Implementation instances and application scenes of the plurality of modules are consistent with those of the corresponding steps, and are not limited by the content disclosed in Embodiment 2.

Through the modules, the first transmission module 402 transmits the power-on signal to the baseboard management controller (BMC), and then whether the initialization data of the BIOS is integral is determined by the BMC, such that integrity of BootBlock that is run by the BIOS first can be verified, and security and credibility of an initial run state of the BIOS can be ensured. After execution of the BIOS is completed, the second transmission module 404 transmits a currently booted and collected metric chain to the BMC for secondary verification, such that integrity of hardware, kernels and other components is verified. Only after integrity verification of the BIOS, hardware, kernels and other components is completed can an operating system be booted. Thus, integrity of the BIOS and other components in the in-band management system can be verified by stages. In this way, a problem that the BMC fails to obtain integrity of other components (such as a Raid card, a graphics card, and an operating system kernel) is solved, and an effect that the BMC can verify the integrity of the BIOS and other components in the server is achieved.

In some optional embodiments, the basic input output system (BIOS) includes a metric chain module 210. As shown in FIG. 2, the metric chain module is used to receive metric value information transmitted by the baseboard management controller (BMC). The metric value information includes a metric value of the initialization data of the BIOS. The metric chain module is further used to obtain integrity information of the components other than a boot program (BootBlock) having the initialization data of the BIOS in the in-band management system. The metric chain module is further used to generate the metric chain information according to the metric value information and the integrity information.

In order to ensure security and reliability of verification data transmitted between the baseboard management controller (BMC) and the basic input output system (BIOS), the BMC and the BIOS ensure security and credibility of interactive data through own trusted roots.

In some optional embodiments, the BIOS further includes a second trusted root management module 220. As shown in FIG. 2, the second trusted root management module is used to exchange a session key with the BMC, obtain a second key, and obtain a first key by the BMC. The second key is used to encrypt the metric value information and generate metric value ciphertext. The second trusted root management module is further used to decrypt the metric value ciphertext through the second key, and obtain the metric value information.

In some optional embodiments, the basic input output system (BIOS) further includes an authentication module 230. As shown in FIG. 2, the second trusted root management module is further used to encrypt the metric chain information through the first key, and obtain metric chain ciphertext. The authentication module is used to transmit the metric chain ciphertext to the BMC, decrypt the metric chain ciphertext through the first key by the baseboard management controller, and obtain the metric chain information.

In some optional embodiments, as shown in FIG. 2, a host trusted root module of the in-band management system includes a key engine and an integrity engine.

Another embodiment of the disclosure further provides a non-volatile readable storage medium. The non-volatile readable storage medium stores a computer program. The computer program is used to execute steps of any one of the method embodiments at runtime.

In an embodiment, the non-volatile readable storage medium may include, but is not limited to, a universal serial bus (USB) flash disk, a read-only memory (ROM), a random access memory (RAM), a mobile hard disk, a magnetic disk, an optical disk, and various media capable of storing computer programs.

Yet another embodiment of the disclosure further provides an electronic device. The electronic device includes a memory and a processor. The memory stores a computer program. The processor is configured to run the computer program so as to execute steps of any one of the method embodiments.

In an embodiment, the electronic device may further include a transmission device and an input/output device. The transmission device is connected to the processor. The input/output device is connected to the processor.

Reference may be made to instances described in the embodiments and embodiments for specific instances in the embodiment, which will not be repeated in the embodiment herein.

Obviously, those skilled in the art should understand that all modules or steps of the disclosure may be implemented with a general-purpose computation apparatus, and may be centralized on a single computation apparatus or distributed on a network consisting of a plurality of computation apparatuses. The modules or steps may be implemented with program codes executable by the computation apparatus, such that the modules or steps may be stored in a storage apparatus so as to be executed by the computation apparatus. Moreover, in some cases, the steps shown or described may be executed in an order different from that herein, the modules or steps may be fabricated separately as individual integrated circuit modules, or a plurality of modules or steps in the modules or steps may be fabricated as a single integrated circuit module for implementation. Thus, the disclosure is not limited to any particular combination of hardware and software.

What are described above are merely preferred embodiments of the disclosure and are not intended to limit the disclosure, and various changes and modifications can be made by those skilled in the art. Any modifications, equivalent substitutions, improvements, and the like within the principles of the disclosure are intended to be included within the protection scope of the disclosure.

1. A verification method for a server, applied to a baseboard management controller, wherein the server comprises an in-band management system, and the verification method comprises:
determining, in a case that a power state of the in-band management system is a powered-on state, whether initialization data of a basic input output system in the in-band management system is integral, and obtaining a determination result;
outputting, in a case that the determination result indicates that the initialization data of the basic input output system in the in-band management system is integral, a power-up instruction to the in-band management system, running the basic input output system, and transmitting metric chain information; and
verifying, according to the metric chain information which is received, integrity of components other than the initialization data of the basic input output system in the in-band management system.

2. The verification method according to claim 1, further comprising:
inspecting, before whether the initialization data of the basic input output system is integral is determined, the power state of the in-band management system, wherein the power state comprises: the powered-on state, a run state, and a powered-off state.

3. The verification method according to claim 2, wherein determining whether the initialization data of the basic input output system in the in-band management system is integral, and obtaining the determination result comprise:
computing a metric value of the initialization data of the basic input output system, and obtaining metric value information; and
determining whether the metric value information is integral according to a reference value library, and obtaining the determination result, wherein the reference value library comprises integrity values of a plurality of components of the basic input output system corresponding to the basic input output system.

4. The verification method according to claim 3, further comprising:
obtaining an update request of the basic input output system and an updated basic input output system (BIOS) file, wherein the BIOS file comprises updated integrity values of the plurality of components of the basic input output system;
parsing the BIOS file according to the update request, and obtaining an integrity value set corresponding to the update request; and
updating the reference value library based on the integrity value set.

5. The verification method according to claim 3, further comprising:
powering off, in a case that the determination result indicates that the initialization data of the basic input output system in the in-band management system is not integral, the components other than the initialization data of the basic input output system in the in-band management system.

6. The verification method according to claim 3, further comprising:
transmitting the metric value information to the basic input output system, and generating the metric chain information by the basic input output system according to the metric value information and integrity information of the components other than the initialization data of the basic input output system in the in-band management system.

7. The verification method according to claim 6, wherein transmitting the metric value information to the basic input output system comprises:
exchanging a session key with the basic input output system, obtaining a first key, and obtaining a second key by the basic input output system;
encrypting the metric value information through the second key, and generating metric value ciphertext; and
transmitting the metric value ciphertext to the basic input output system, decrypting the metric value ciphertext by the basic input output system according to the second key, and obtaining the metric value information.

8. The verification method according to claim 7, further comprising:
decrypting, before verifying, according to the metric chain information, the integrity of the components other than the initialization data of the basic input output system in the in-band management system, metric chain ciphertext through the first key, and obtaining the metric chain information, wherein the metric chain ciphertext is obtained by the basic input output system according to the metric value information and the integrity information of the components other than the initialization data of the basic input output system in the in-band management system.

9. The verification method according to claim 6, further comprising:
recording a first moment of transmitting the metric value information to the basic input output system and a second moment of receiving the metric chain information;
determining whether a time difference between the first moment and the second moment is greater than a preset threshold; and
powering off, in a case that a determination result indicates that the time difference between the first moment and the second moment is greater than the preset threshold, the components other than the initialization data of the basic input output system in the in-band management system.

10. A verification method for a server, wherein the server comprises an in-band management system, the verification method is applied to a basic input output system in the in-band management system, and the verification method comprises:
transmitting, in a case that a power state of the in-band management system is a powered-on state, a power-on signal to a baseboard management controller, determining whether initialization data of the basic input output system is integral by the baseboard management controller, and outputting a power-up instruction in a case that a determination result indicates that the initialization data of the basic input output system is integral; and
controlling, in a case of receiving the power-up instruction, the basic input output system to be run, transmitting metric chain information to the baseboard management controller, and verifying, by the baseboard management controller, integrity of components other than the initialization data of the basic input output system in the in-band management system according to the metric chain information which is received.

11. The verification method according to claim 10, further comprising:
receiving, in a case that the determination result indicates that the initialization data of the basic input output system is not integral, a control signal transmitted by the baseboard management controller, wherein the control signal is used to control the components other than the initialization data of the basic input output system in the in-band management system to be powered off.

12. The verification method according to claim 10, further comprising:
transmitting an update request of the basic input output system and an updated basic input output system (BIOS) file to the baseboard management controller, parsing the BIOS file by the baseboard management controller according to the update request, obtaining an integrity value set corresponding to the update request, and updating a reference value library based on the integrity value set, wherein the BIOS file comprises updated integrity values of a plurality of components of the basic input output system.

13. The verification method according to claim 10, further comprising:
receiving metric value information transmitted by the baseboard management controller, wherein the metric value information comprises a metric value of the initialization data of the basic input output system;
obtaining integrity information of the components other than the initialization data of the basic input output system in the in-band management system; and
generating the metric chain information according to the metric value information and the integrity information.

14. The verification method according to claim 13, wherein receiving the metric value information transmitted by the baseboard management controller comprises:
exchanging a session key with the baseboard management controller, obtaining a second key, and obtaining a first key by the baseboard management controller, wherein the second key is used to encrypt the metric value information and generate metric value ciphertext; and
decrypting the metric value ciphertext through the second key, and obtaining the metric value information.

15. The verification method according to claim 14, wherein transmitting the metric chain information to the baseboard management controller comprises:
encrypting the metric chain information through the first key, and obtaining metric chain ciphertext; and
transmitting the metric chain ciphertext to the baseboard management controller, decrypting the metric chain ciphertext through the first key by the baseboard management controller, and obtaining the metric chain information.

16. The verification method according to claim 15, further comprising:
receiving, in a case that a time difference between a first moment and a second moment is greater than a preset threshold, a control signal transmitted by the baseboard management controller, wherein the first moment is a moment of receiving the metric value information transmitted by the baseboard management controller, the second moment is a moment of transmitting the metric chain information to the baseboard management controller, and the control signal is used to control the components other than the initialization data of the basic input output system in the in-band management system to be powered off.

17-18. (canceled)

19. A non-volatile readable storage medium, storing a computer program, wherein when the computer program is executed by a processor, the computer program implement to:
determine, in a case that a power state of the in-band management system is a powered-on state, whether initialization data of a basic input output system in the in-band management system is integral, and obtain a determination result;
output, in a case that the determination result indicates that the initialization data of the basic input output system in the in-band management system is integral, a power-up instruction to the in-band management system, run the basic input output system, and transmit metric chain information; and
verify, according to the metric chain information which is received, integrity of components other than the initialization data of the basic input output system in the in-band management system.

20. An electronic device, comprising a memory, a processor, and a computer program stored in the memory and runnable on the processor, wherein when the computer program is executed by the processor, steps of the verification method according to claim 1.

21. The verification method according to claim 1, further comprising:
completing basic input output system (BIOS) refreshing, by the baseboard management controller, wherein the baseboard management controller integrates a functional logic of the BIOS refreshing, and the functional logic configured to verify integrity and legality of a BIOS file to be refreshed;
parsing the BIOS file, wherein the BIOS file comprises a plurality of BIOS components, and computing integrity values of all the components, so as to obtain a integrity value set;
updating the reference value library at runtime, wherein the integrity value set is updated to the reference value library at runtime;
updating the reference value library, wherein every time the baseboard management controller which is booted creates the reference value library at runtime according to the reference value library persistently stored and protected by a trusted root.

22. The verification method according to claim 1, wherein
the metric chain information is a integrity information of various components collected based on a trusted root in a case that a computer is booted.
